(19) United States
(12) Patent Application Publication
(10) Pub. No.: US 2013/0019085 A1
(43) Pub. Date: Jan. 17, 2013

(54) Efficient Recombining for Dual Path Execution

(71) Applicants: Harold W. Cain, III, Hartsdale, NY (US); David M. Daly, Croton on Hudson, NY (US); Michael C. Huang, Rochester, NY (US); Jose E. Moreira, Irvington, NY (US); IL Park, Seoul (KR)

(72) Inventors: Harold W. Cain, III, Hartsdale, NY (US); David M. Daly, Croton on Hudson, NY (US); Michael C. Huang, Rochester, NY (US); Jose E. Moreira, Irvington, NY (US); IL Park, Seoul (KR)

(73) Assignee: International Business Machines Corporation, Armonk, NY (US)

(21) Appl. No.: 13/180,634

(22) Filed: Jul. 12, 2011

(51) Int. Cl. G06F 9/38

(52) U.S. Cl. 712/233; 712/E09.045

(57) ABSTRACT

A mechanism is provided for reducing a penalty for executing a correct branch of a branch instruction. An execution unit in a processor of a data processing system executes a first branch of the branch instruction from a main thread of a processor and executes a second branch of the branch instruction from an assist thread of the processor. The execution unit determines whether the main thread is a correct branch of the branch instruction or the assist thread is the correct branch of the branch instruction. Responsive to the assist thread being the correct branch of the branch instruction, the execution unit pauses execution of the branch instruction on both the main thread and the assist thread. The execution unit then properly inherits a context of the main thread in order that execution of the second branch may continue.

### BACKGROUND

The present application relates generally to an improved data processing apparatus and method and more specifically to mechanisms for efficient recombining for dual path execution.

Dual path execution reduces branch misprediction penalties by forking a second path and executing instructions from both paths following a conditional branch instruction in code being executed by a processor. Heavily pipelined processors may have several instructions in flight at once. Some of these instructions are branch instructions that may change the address of the next instruction to execute. In dual path execution, the processor speculatively executes both branches of the branch instruction, such that the processor executes one branch using a main thread and executes the other branch using an assist thread. However, in dual path execution, the correct execution normally continues on the main thread. Therefore, if the processor identifies that the assist thread is executing the correct branch of the code, the state and instructions of the assist thread must be migrated back to the main thread. This means that the processor must return to the point where the branch instruction occurred and re-execute correct code that was previously executed on the assist thread on the main thread so that the correct execution continues on the main thread. This migration may delay the execution of the code by the processor and/or require additional hardware complexity and overhead.

### SUMMARY

In one illustrative embodiment, a method, in a data processing system, is provided for reducing a penalty for executing a correct branch of a branch instruction. The illustrative embodiment executes a first branch of the branch instruction from a main thread of a processor. The illustrative embodiment executes a second branch of the branch instruction from an assist thread of the processor. The illustrative embodiment determines whether the main thread is a correct branch of the branch instruction or the assist thread is the correct branch of the branch instruction. The illustrative embodiment pauses execution of the branch instruction on both the main thread and the assist thread in response to the assist thread being the correct branch of the branch instruction. The illustrative embodiment properly inherits a context of the main thread in order that execution of the second branch may continue until the branch instruction completes.

In other illustrative embodiments, a computer program product comprising a computer useable or readable medium having a computer readable program is provided. The computer readable program, when executed on a computing device, causes the computing device to perform various ones of, and combinations of the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a block diagram of a data processing system in which illustrative embodiments may be implemented;

FIG. 2 depicts an exemplary block diagram of a conventional dual threaded processor design showing functional units and registers in accordance with an illustrative embodiment;

FIG. 3 depicts an exemplary functional block diagram of a mechanism implemented in a conventional dual threaded processor design that reduces the penalty for executing a correct branch of a branch instruction on an assist thread in accordance with a preferred illustrative embodiment;

FIG. 4 depicts another exemplary functional block diagram of a mechanism implemented in a conventional dual threaded processor design that reduces the penalty for executing a correct branch of a branch instruction on an assist thread in accordance with an alternative illustrative embodiment;

FIG. 5 depicts an exemplary flow diagram of an operation performed by a mechanism that reduces the penalty for executing a correct branch of a branch instruction on an assist thread in accordance with a preferred illustrative embodiment; and

FIG. 6 depicts an alternative exemplary flow diagram of an operation performed by a mechanism that reduces the penalty for executing a correct branch of a branch instruction on an assist thread in accordance with an alternative illustrative embodiment.

### DETAILED DESCRIPTION

The illustrative embodiments provide a mechanism that reduces the overhead of dual-path execution when the correct path of a branch instruction is executed on an assist thread. When dual path execution is used to execute a branch instruction, a processor executes one branch using a main thread and launches an assist thread to execute the other branch. At the time the branch is resolved, either the instructions executing on the assist thread or the instructions executing on the main thread should be continued. If the processor determines that the main thread is executing the correct branch, the processor squashes the assist thread and continues execution on the main thread with no penalty. A penalty may be considered computer cycles that are utilized scheduling, fetching, and/or executing instructions of an incorrect branch of a branch instruction. However, if the processor determines that the assist thread is executing the correct branch, then the illustrative embodiments provide the processor with a mechanism to properly inherit the context of the main thread so that execution may continue on the assist thread.

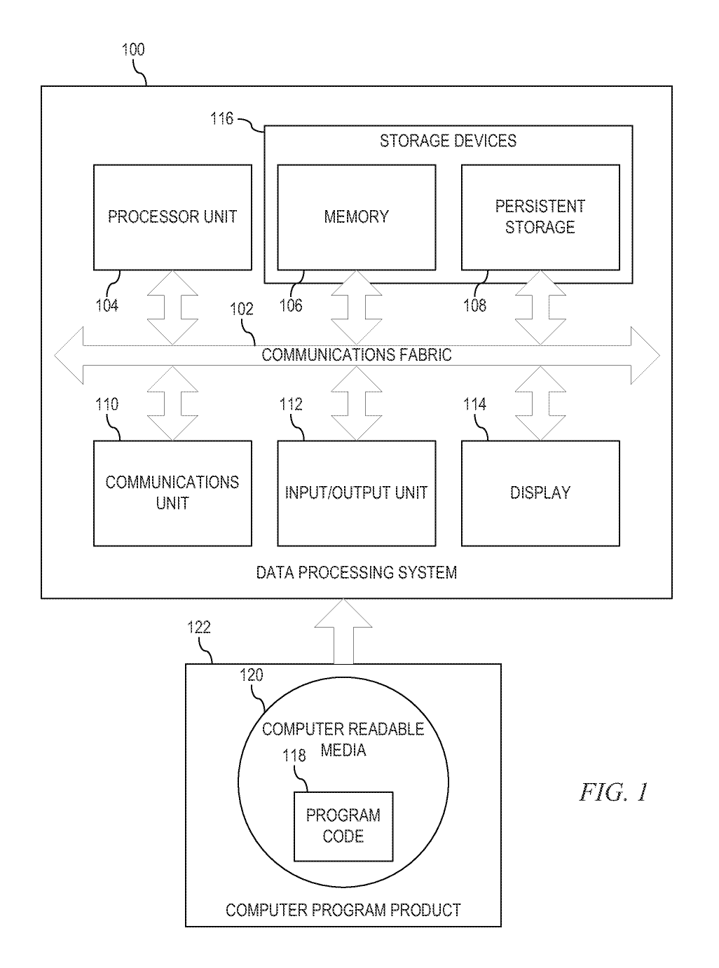

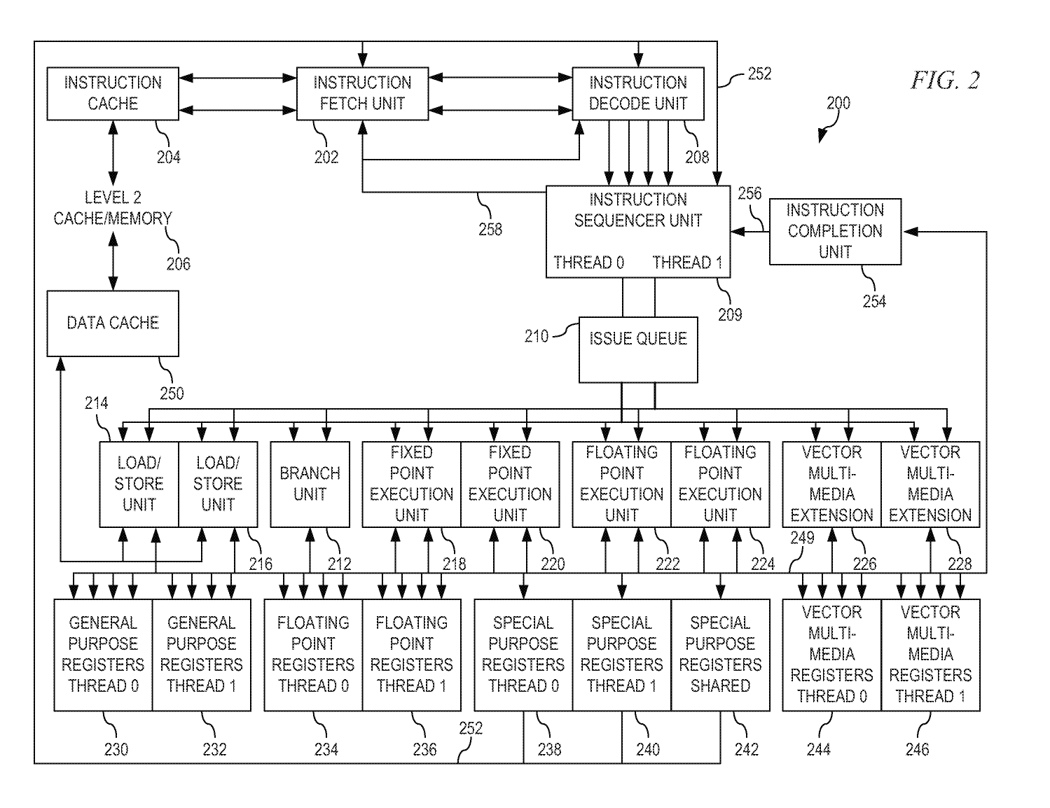

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. While the description following FIGS. 1 and 2 will focus primarily on a single data processing device implementation of using power proxies combined with on-chip actuators to meet a defined power target, this is only an example and is not intended to state or imply any limitation with regard to the features of the present invention. To the contrary, the illustrative embodiments are intended to include distributed data processing environments and embodiments in which power proxies combined with on-chip actuators may be used to meet a defined power target.

With reference now to the figures and in particular with reference to FIGS. 1-2, example diagrams of data processing environments are provided in which illustrative embodiments of the present invention may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a block diagram of a data processing system in which illustrative embodiments may be implemented. Data processing system 100 is an example of a computer, in which computer usable program code or instructions implementing the processes may be located for the illustrative embodiments. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices 116. A storage device is any piece of hardware that is capable of storing information, such as, for example, without limitation, data, program code in functional form, and/or other suitable information either on a temporary basis and/or a permanent basis. Memory 106, in these examples, may be, for example, a random access memory or any other suitable volatile or non-volatile storage device. Persistent storage 108 may take various forms depending on the particular implementation. For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard, a mouse, and/or some other suitable input device. Further, input/output unit 112 may send output to a printer. Display 114 provides a mechanism to display information to a user.

Instructions for the operating system, applications and/or programs may be located in storage devices 116, which are in communication with processor unit 104 through communications fabric 102. In these illustrative examples the instructions are in a functional form on persistent storage 108. These instructions may be loaded into memory 106 for execution by processor unit 104. The processes of the different embodiments may be performed by processor unit 104 using computer implemented instructions, which may be located in a memory, such as memory 106.

These instructions are referred to as program code, computer usable program code, or computer readable program code that may be read and executed by a processor in processor unit 104. The program code in the different embodiments may be embodied on different physical or tangible computer readable media, such as memory 106 or persistent storage 108.

Program code 118 is located in a functional form on computer readable media 120 that is selectively removable and may be loaded onto or transferred to data processing system 100 for execution by processor unit 104. Program code 118 and computer readable media 120 form computer program product 122 in these examples. In one example, computer readable media 120 may be in a tangible form, such as, for example, an optical or magnetic disc that is inserted or placed into a drive or other device that is part of persistent storage 108 for transfer onto a storage device, such as a hard drive that is part of persistent storage 108. In a tangible form, computer readable media 120 also may take the form of a persistent storage, such as a hard drive, a thumb drive, or a flash memory that is connected to data processing system 100. The tangible form of computer readable media 120 is also referred to as computer recordable storage media. In some instances, computer readable media 120 may not be removable.

Alternatively, program code 118 may be transferred to data processing system 100 from computer readable media 120 through a communications link to communications unit 110 and/or through a connection to input/output unit 112. The communications link and/or the connection may be physical or wireless in the illustrative examples. The computer readable media also may take the form of non-tangible media, such as communications links or wireless transmissions containing the program code.

In some illustrative embodiments, program code 118 may be downloaded over a network to persistent storage 108 from another device or data processing system for use within data processing system 100. For instance, program code stored in a computer readable storage medium in a server data processing system may be downloaded over a network from the server to data processing system 100. The data processing system providing program code 118 may be a server computer, a client computer, or some other device capable of storing and transmitting program code 118.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 100 is any hardware apparatus that may store data. Memory 106, persistent storage 108 and computer readable media 120 are examples of storage devices in a tangible form. In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

Referring to FIG. 2, an exemplary block diagram of a conventional dual threaded processor design showing functional units and registers is depicted in accordance with an illustrative embodiment. Processor 200 may be implemented as processing unit 104 in FIG. 1 in these illustrative examples. Processor 200 comprises a single integrated circuit superscalar microprocessor with dual-thread simultaneous multi-threading (SMT) that may also be operated in a single threaded mode. Accordingly, as discussed further herein below, processor 200 includes various units, registers, buffers, memories, and other sections, all of which are formed by integrated circuitry. Also, in an illustrative embodiment, processor 200 operates according to reduced instruction set computer (RISC) techniques.

As shown in FIG. 2, instruction fetch unit (IFU) 202 connects to instruction cache 204. Instruction cache 204 holds instructions for multiple programs (threads) to be executed. Instruction cache 204 also has an interface to level 2 (L2) cache/memory 206. IFU 202 requests instructions from instruction cache 204 according to an instruction address, and passes instructions to instruction decode unit 208. In an illustrative embodiment, IFU 202 may request multiple instructions from instruction cache 204 for up to two threads at the same time. Instruction decode unit 208 decodes multiple instructions for up to two threads at the same time and passes decoded instructions to instruction sequencer unit (ISU) 209.

Processor 200 may also include issue queue 210, which receives decoded instructions from ISU 209. Instructions are stored in the issue queue 210 while awaiting dispatch to the appropriate execution units. For an out-of order processor to operate in an in-order manner, ISU 209 may selectively issue instructions quickly using false dependencies between each instruction. If the instruction does not produce data, such as in a read after write dependency, ISU 209 may add an additional source operand (also referred to as a consumer) per instruction to point to the previous target instruction (also referred to as a producer). Issue queue 210, when issuing the producer, may then wakeup the consumer for issue. By introducing false dependencies, a chain of dependent instructions may then be created, whereas the instructions may then be issued only in-order, ISU 209 uses the added consumer for instruction scheduling purposes and the instructions, when executed, do not actually use the data from the added dependency. Once ISU 209 selectively adds any required false dependencies, then issue queue 210 takes over and issues the instructions in order for each thread, and outputs or issues instructions for each thread to execution units 212, 214, 216, 218, 220, 222, 224, 226, and 228 of the processor. This process will be described in more detail in the following description.

In an illustrative embodiment, the execution units of the processor may include branch unit 212, load/store units (LSUA) 214 and (LSUB) 216, fixed point execution units (FXUA) 218 and (FXUB) 220, floating point execution units (FPUA) 222 and (FPUB) 224, and vector multimedia extension units (VMXA) 226 and (VMXB) 228. Execution units 212, 214, 216, 218, 220, 222, 224, 226, and 228 are fully shared across both threads, meaning that execution units 212, 214, 216, 218, 220, 222, 224, 226, and 228 may receive instructions from either or both threads. The processor includes multiple register sets 230, 232, 234, 236, 238, 240, 242, 244, and 246, which may also be referred to as architected register files (ARFs).

An ARF is a file where completed data is stored once an instruction has completed execution, ARFs 230, 232, 234, 236, 238, 240, 242, 244, and 246 may store data separately for each of the two threads and by the type of instruction, namely general purpose registers (GPRs) 230 and 232, floating point registers (FPRs) 234 and 236, special purpose registers (SPRs) 238 and 240, and vector registers (VRs) 244 and 246. Separately storing completed data by type and by thread assists in reducing processor contention while processing instructions.

The processor additionally includes a set of shared special purpose registers (SPR) 242 for holding program states, such as an instruction pointer, stack pointer, or processor status word, which may be used on instructions from either or both threads. Execution units 212, 214, 216, 218, 220, 227, 224, 226, and 778 are connected to ARFs 230, 232, 234, 236, 238, 240, 242, 244, and 246 through internal bus structure 249.

In order to execute a floating point instruction, FPUA 222 and FPUB 224 retrieves register source operand information, which is input data required to execute an instruction, from FPRs 234 and 236, if the instruction data required to execute the instruction is complete or if the data has passed the point of flushing in the pipeline. Complete data is data that has been generated by an execution unit once an instruction has completed execution and is stored in an ARF, such as ARFs 230, 232, 234, 236, 238, 240, 242, 244, and 246. Incomplete data is data that has been generated during instruction execution where the instruction has not completed execution. FPUA 222 and FPUB 224 input their data according to which thread each executing instruction belongs to. For example, FPUA 222 inputs completed data to FPR 234 and FPUB 224 inputs completed data to FPR 236, because FPUA 222, FPUB 224, and FPRs 234 and 236 are thread specific.

During execution of an instruction, FPUA 222 and FPUB 224 output their destination register operand data, or instruction data generated during execution of the instruction, to FPRs 234 and 236 when the instruction has passed the point of flushing in the pipeline. During execution of an instruction, FXUA 218, FXUB 220, LSUA 214, and LSUB 216 output their destination register operand data, or instruction data generated during execution of the instruction, to GPRs 230 and 232 when the instruction has passed the point of flushing in the pipeline. During execution of a subset of instructions, FXUA 218, FXUB 220, and branch unit 212 output their destination register operand data to SPRs 238, 240, and 242 when the instruction has passed the point of flushing in the pipeline. Program states, such as an instruction pointer, stack pointer, or processor status word, stored in SPRs 238 and 240 indicate thread priority 252 to ISU 209. During execution of an instruction, VMXA 226 and VMXB 228 output their destination register operand data to VRs 244 and 246 when the instruction has passed the point of flushing in the pipeline.

Data cache 250 may also have associated with it a non-cacheable unit (not shown) which accepts data from the processor and writes it directly to level 2 cache/memory 206. In this way, the non-cacheable unit bypasses the coherency protocols required for storage to cache.

In response to the instructions input from instruction cache 204 and decoded by instruction decode unit 208, ISU 209 selectively dispatches the instructions to issue queue 210 and then onto execution units 212, 214, 216, 218, 220, 222, 224, 226, and 228 with regard to instruction type and thread. In turn, execution units 212, 214, 216, 218, 220, 222, 224, 226, and 228 execute one or more instructions of a particular class or type of instructions. For example, FXUA 218 and FXUB 220 execute fixed point mathematical operations on register source operands, such as addition, subtraction, ANDing, ORing and XORing, FPUA 222 and FPUB 224 execute floating point mathematical operations on register source operands, such as floating point multiplication and division. LSUA 214 and LSUB 216 execute load and store instructions, which move operand data between data cache 250 and ARFs 230, 232, 234, and 236. VMXA 226 and VMXB 228 execute single instruction operations that include multiple data. Branch unit 212 executes branch instructions which conditionally alter the flow of execution through a program by modifying the instruction address used by IFU 202 to request instructions from instruction cache 204.

Instruction completion unit 254 monitors internal bus structure 249 to determine when instructions executing in execution units 212, 214, 216, 218, 220, 222, 224, 226, and 228 are finished writing their operand results to ARFs 230, 232, 234, 236, 238, 240, 242, 244, and 246. Instructions executed by branch unit 212, FXUA 218, FXUB 220, LSUA 214, and LSUB 216 require the same number of cycles to execute, while instructions executed by FPUA 222, FPUB 224, VMXA 226, and VMXB 228 require a variable, and a larger number of cycles to execute. Therefore, instructions that are grouped together and start executing at the same time do not necessarily finish executing at the same time. “Completion” of an instruction means that the instruction is finishing executing in one of execution units 212, 214, 216, 218, 220, 222, 224, 226, or 228, has passed the point of flushing, and all older instructions have already been updated in the architected state, since instructions have to be completed in order. Hence, the instruction is now ready to complete and update the architected state, which means updating the final state of the data as the instruction has been completed. The architected state can only be updated in order, that is, instructions have to be completed in order and the completed data has to be updated as each instruction completes.

Instruction completion unit 254 monitors for the completion of instructions, and sends control information 256 to ISU 209 to notify ISU 209 that more groups of instructions can be dispatched to execution units 212, 214, 216, 218, 220, 222, 224, 226, and 228. ISU 209 sends dispatch signal 258, which serves as a throttle to bring more instructions down the pipeline to the dispatch unit, to IFU 202 and instruction decode unit 208 to indicate that it is ready to receive more decoded instructions. White processor 200 provides one detailed description of a single integrated circuit superscalar microprocessor with dual-thread simultaneous multi-threading (SMT) that may also be operated in a single threaded mode, the illustrative embodiments are not limited to such microprocessors. That is, the illustrative embodiments may be implemented in any type of processor using a pipeline technology.

Again, when dual path execution is used to execute a branch instruction, a processor executes one branch using a main thread and launches an assist thread to execute the other branch. At the time the branch is resolved, either the instructions executing on the assist thread or the instructions executing on the main thread should be continued. If the processor determines that the main thread is executing the correct branch, the processor squashes the assist thread and continues execution on the main thread with no penalty. However, if the processor determines that the assist thread is executing the correct branch, then the illustrative embodiments provide the processor with a mechanism to properly inherit the context of the main thread so that execution may continue on the assist thread.

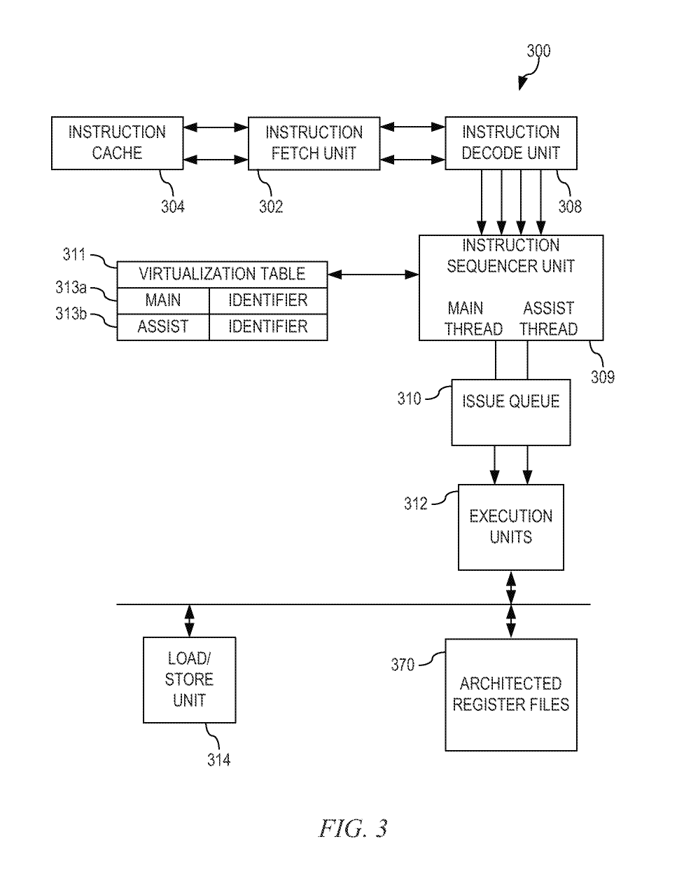

FIG. 3 depicts an exemplary functional block diagram of a mechanism implemented in a conventional dual threaded processor design that reduces the penalty for executing a correct branch of a branch instruction on an assist thread in accordance with a preferred illustrative embodiment. Processor 300 is a simplified view of a processor, such as processor 200 in FIG. 2. Processor 300 comprises instruction fetch unit (IFU) 302 that requests instructions from instruction cache 304 according to an instruction address, and passes instructions to instruction decode unit 308. In an illustrative embodiment, IFU 302 may request multiple instructions from instruction cache 304 for up to two threads at the same time. Instruction decode unit 308 decodes multiple instructions for up to two threads at the same time and passes decoded instructions to instruction sequencer unit (ISU) 309.

However, if instruction decode unit 308 encounters a branch instruction, then instruction decode unit 308 decodes one branch of the branch instruction so that that branch will be executed on a main thread and decodes the other branch of the branch instruction so that the other branch will be executed on an assist thread. The assist thread may be a full hardware thread that is restricted in some manner for use as described in the illustrative embodiments or a limited hardware thread for use as described in the illustrative embodiments as well as other uses not described herein. In accordance with this illustrative embodiment, upon receiving the decoded instructions, ISU 309 uses thread virtualization table 311 to add a thread identifier (ID) to each of the branches of the branch instruction. Thread virtualization table 311 comprises main thread identifier 313a for the main thread and assist thread identifier 313b for the assist thread. Specific to this illustrative embodiment, main thread identifier 313a and assist thread identifier 313b differ by one bit, which is a bit that may be ignored by any external resource, such as architected register files (ARFs) 370. Issue queue 310 then receives the decoded instructions from ISU 309 and issues the instructions for each thread to the appropriate execution units of processor 300.

During normal execution of the assist thread and the main thread, execution units 312 accomplishes the reading and writing of architectural state using main thread identifier 313a for the main thread and assist thread identifier 313b for the assist thread from thread virtualization table 311. Instruction sequencer unit 309 provides access to non-renamed register files and thread-specific static random-access memories (SRAMs), which may include special-purpose registers, machine state registers, address translation control registers, timer registers, or the like, by first reading a physical thread ID from thread virtualization table 311 addressed by the virtual thread ID, and concatenating this physical thread identifier with the register number or random access memory (RAM) address. A mapping from assist thread to physical thread identifier may not exist for some architectural resources that are not available to assist threads.

The main thread and the assist thread use execution units 312 to execute instructions. At the time execution units 312 resolves the branches, execution units 312 identifies whether the main thread is executing the correct branch or the assist thread is executing the correct branch. If execution units 312 identify that the main thread is executing the correct branch, then execution units 312 squashes the assist thread and continues execution on the main thread with no penalty. However, if execution units 312 identify that the assist thread is executing the correct branch, then execution units 312 pause execution on both the main thread and the assist thread. Execution units 312 then updates thread virtualization table 311 to discard the current assist thread identifier 313b and change the assist thread's virtual identifier to main thread identifier 313a. By execution units 312 changing the assist thread's virtual identifier to main thread identifier 313a, the assist thread properly inherits the context of the main thread so that execution may continue on the assist thread. After execution units 312 change the assist thread's virtual identifier to main thread identifier 313a, execution units 312 squashes the main thread and continues execution on the assist thread using the main thread identifier with no penalty.

Memory dependences are also tracked using thread ID. As indicated previously, in accordance with the illustrative embodiments, main thread identifier 313a differs from assist thread identifier 313b by a single lower order bit. An additional “dual-path main thread” bit may also be added to the processor core's store queue indicating whether the store belongs to, for example, the post-branch portion of the main thread (if the dual-path main thread bit is a 1). When execution units 312 searches store queue for dependence checking by subsequent main thread loads, execution units 312 compares the thread ids (which will differ between the main thread and the assist thread, but will be common between the main thread and the pre-branch stores), and load store unit 314 ignores the dual path main thread bit in the store queue. When load store unit 314 searches the store queue for dependence checking by assist thread loads, load store unit 314 compares the assist thread ID to store queue entries while ignoring the tower most bit. If these fields match and the dual-path bit is set to 0, then load store unit 314 recognizes that the store must either be an assist thread store or a pre-branch store.

When execution units 312 resolves the branch outcome, execution units 312 must clean up the dual path main thread bits used during dual path execution. Two alternative implementations are possible. In one embodiment, the dual path bit is no longer set after branch resolution. If the main thread executed the correct branch path, execution units 312 continues executing the main thread, but does not set the dual path bit. Further dual path executions are not allowed until all the store reorder queue (SRQ) entries for the thread with the dual path bit drain from the SRQ. If the assist thread executed the correct branch path, execution units 312 continues executing the assist thread and snoops the SRQ for the assist thread ID and the main thread of the main thread with dual path not set. Additionally, execution units 312 invalidates any entries found in the SRQ with the main thread and the dual path bit set. Further dual path executions are not allowed until all the SRQ entries from the main thread drain from the SRQ.

In an alternate implementation, on branch resolution, execution units 312 updates the dual path bit in each SRQ entry in order to allow further dual path execution. If the main thread executed correct branch path, execution units 312 clears the dual path bit for all main thread entries and deletes the assist thread entries from the SRQ. If the assist thread executed the correct branch path, execution units 312 changes each SRQ entry containing the main thread ID with the dual path bit not set to the assist thread ID.

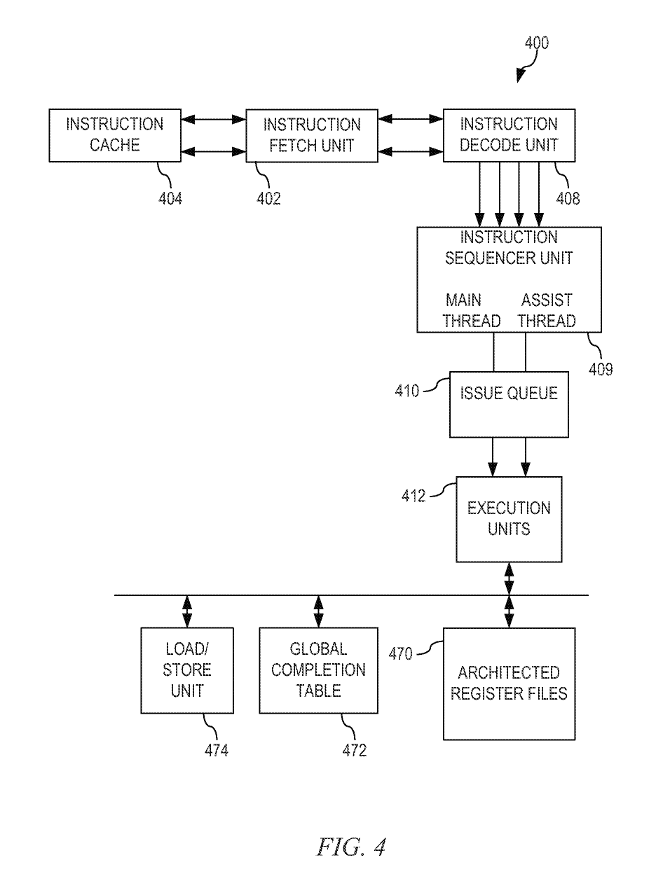

FIG. 4 depicts another exemplary functional block diagram of a mechanism implemented in a conventional dual threaded processor design that reduces the penalty for executing a correct branch of a branch instruction on an assist thread in accordance with an alternative illustrative embodiment. Processor 400 is a simplified view of a processor, such as processor 200 in FIG. 2. Processor 400 comprises instruction fetch unit (IFU) 402 that requests instructions from instruction cache 404 according to an instruction address, and passes instructions to instruction decode unit 408. In an illustrative embodiment, IFU 402 may request multiple instructions from instruction cache 404 for up to two threads at the same time. Instruction decode unit 408 decodes multiple instructions for up to two threads at the same time and passes decoded instructions to instruction sequencer unit (ISU) 409.

However, if instruction decode unit 408 encounters a branch instruction, then instruction decode unit 408 decodes one branch of the branch instruction so that that branch will be executed on a main thread and decodes the other branch of the branch instruction so that the other branch will be executed on an assist thread. Issue queue 410 then receives the decoded instructions from ISU 409 and issues the instructions for each thread to execution units 412 of processor 400.

Execution units 412 then execute the first branch using the main thread and execute the other branch using the assist thread. At the time execution units 412 resolves the branches, execution units 412 identifies whether the main thread is executing the correct branch or the assist thread is executing the correct branch. If execution units 412 identify that the main thread is executing the correct branch, then execution units 412 squashes the assist thread and continues execution on the main thread with no penalty.

However, if execution units 412 identify that the assist thread is executing the correct branch, then execution units 412 pauses execution on both the main thread and the assist thread. Execution units 412 squashes all of the in-flight instructions to the main thread and then moves all in-flight instructions of the assist thread to the main thread by modifying the entries of, for example, a global completion table (GCT) 472, aloud store queue (LSQ) 474, or the like, as well as setting the main thread's program counter to the value of the program counter of the assist thread. In-flight instructions are one or more instructions that are scheduled and/or being executed by a processor. Once all the in-flight instructions are updated, the main thread continues execution using the in-flight instructions that had been intended for the assist thread. At any point during the dual path execution the assist thread needs to access a non-virtualized resource, such as architected register files 470, execution units 412 will stall the assist thread until after branch resolution and path recombining.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart, and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

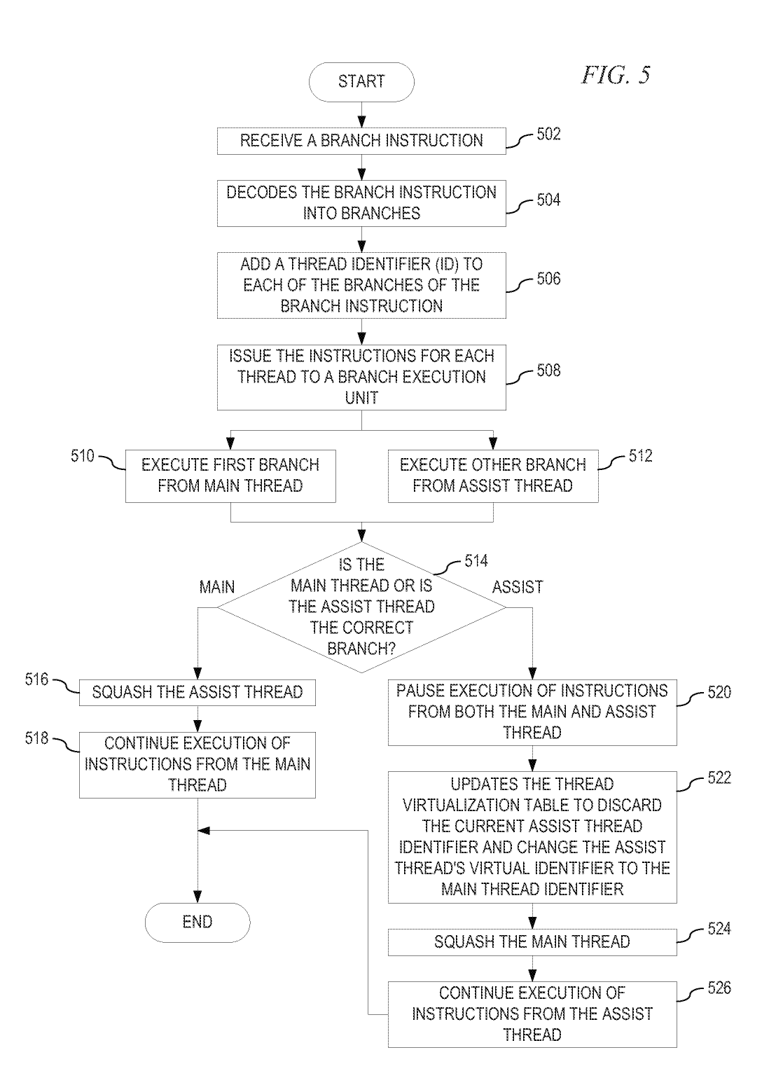

FIG. 5 depicts an exemplary flow diagram of an operation performed by a mechanism that reduces the penalty for executing a correct branch of a branch instruction on an assist thread in accordance with a preferred illustrative embodiment. As the operation begins, an instruction decode unit receives a branch instruction from instruction fetch unit (IFU) (step 502). The instruction decode unit decodes one branch of the branch instruction so that that branch will be executed on a main thread and decodes the other branch of the branch instruction so that the other branch will be executed on an assist thread (step 504). The instruction decode unit then passes the instruction to an instruction sequencer unit (ISU) that, upon receiving the decoded instructions, uses a thread virtualization table to add a thread identifier (ID) to each of the branches of the branch instruction (step 506). The thread virtualization table comprises a main thread identifier for the main thread and an assist thread identifier for the assist thread. An issue queue then receives the decoded instructions from the ISU and issues the instructions for each thread to execution units on a processor of the data processing system (step 508).

Execution units then execute instructions from the main thread (step 510) and also execute instructions from the assist thread (step 512). At a time during the execution of the branches of the branch instruction, the execution units resolves the branches, which involves the execution units determining whether the main thread is executing the correct branch or the assist thread is executing the correct branch (step 514). If at step 514 the execution units identifies that the main thread is executing the correct branch, then the execution units squashes the assist thread (step 516) and continues execution on the main thread with no penalty until the instruction completes (step 518), with the operation terminating thereafter.

However, if at step 514 the execution units identifies that the assist thread is executing the correct branch, then the execution units pauses execution on both the main thread and the assist thread (step 520). The execution units updates the thread virtualization table to discard the current assist thread identifier and change the assist thread's virtual identifier to the main thread identifier (step 522). By the execution units changing the assist thread's virtual identifier to the main thread identifier, the assist thread properly inherits the context of the main thread so that execution may continue on the assist thread without penalty. After the execution units changes the assist thread's virtual identifier to the main thread identifier, the execution units squashes the main thread (step 524) and continues execution on the assist thread using the main thread identifier with no penalty until the instruction completes (step 526), with the operation terminating thereafter.

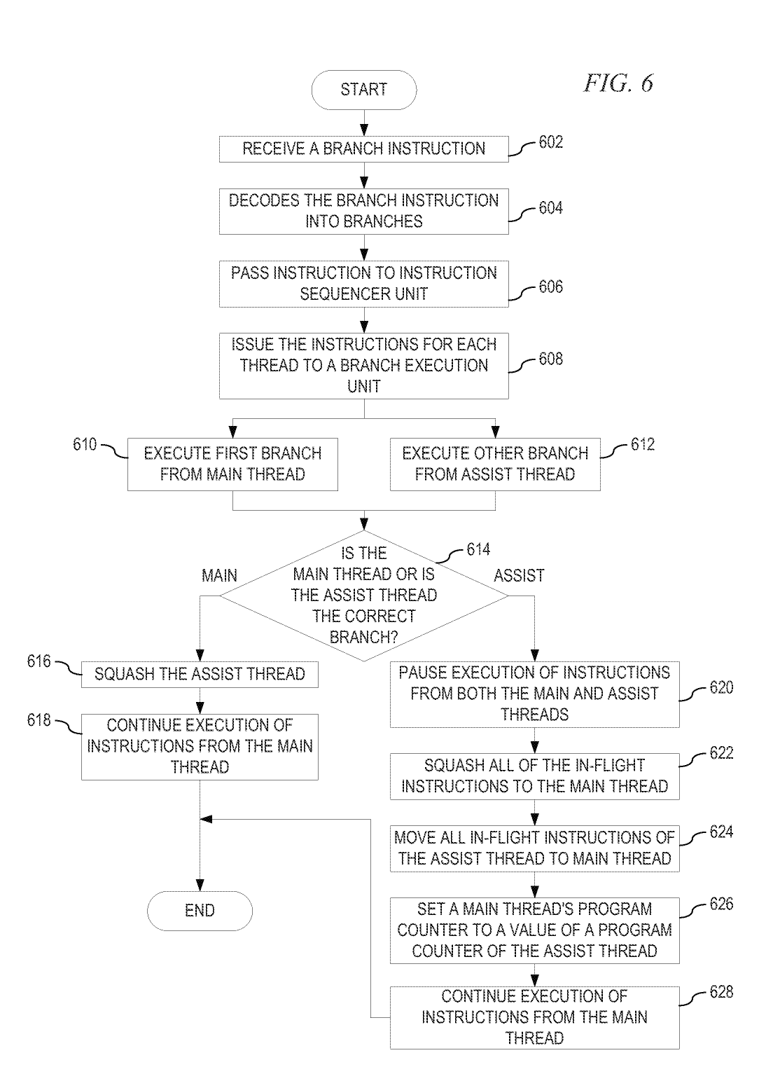

FIG. 6 depicts an alternative exemplary flow diagram of an operation performed by a mechanism that reduces the penalty for executing a correct branch of a branch instruction on an assist thread in accordance with an alternative illustrative embodiment. As the operation begins, an instruction decode unit receives a branch instruction from instruction fetch unit (IFU) (step 602). The instruction decode unit decodes one branch of the branch instruction so that that branch will be executed on a main thread and decodes the other branch of the branch instruction so that the other branch will be executed on an assist thread (step 604). The instruction decode unit then passes the instruction to an instruction sequencer unit (ISU) (step 606). An issue queue then receives the decoded instructions from the ISU and issues the instructions for each thread to execution units on a processor of the data processing system (step 608).

Execution units then execute instructions from the main thread (step 610) and also execute instructions from the assist thread (step 612). At a time during the execution of the branches of the branch instruction, the execution units resolves the branches, which involves the execution units determining whether the main thread is executing the correct branch or the assist thread is executing the correct branch (step 614). If at step 614 the execution units identifies that the main thread is executing the correct branch, then the execution units squashes the assist thread (step 616) and continues execution on the main thread until the branch instruction completes (step 618), with the operation terminating thereafter.

However, if at step 614 the execution units identifies that the assist thread is executing the correct branch, then the execution units pauses execution on both the main thread and the assist thread (step 620). The execution units squashes all of the in-flight instructions to the main thread (step 622) and then moves all in-flight instructions of the assist thread to the main thread by modifying the entries in one or more of a global completion table (GCT), a load store queue (LSQ), or the like (step 624). The execution units also sets a main thread's program counter to a value of a program counter of the assist thread (step 626). Once all the in-flight instructions are updated, the execution units continues execution on the main thread using the in-flight instructions that had been intended for the assist thread until the instruction completes (step 628), with the operation terminating thereafter. At any point during the dual path execution the assist thread needs to access a non-virtualized resource, the execution units stalls the assist thread until after branch resolution and path recombining.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s), should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for reducing the penalty for executing the correct branch on the assist thread. When dual path execution is used to execute a branch instruction, a processor executes one branch using a main thread and launches an assist thread to execute the other branch. At the time the branch is resolved, either the instructions executing on the assist thread or the instructions executing on the main thread should be continued, the processor determines that the main thread is executing the correct branch, the processor squashes the assist thread and continues execution on the main thread with no penalty. However, if the processor determines that the assist thread is executing the correct branch, then the illustrative embodiments provide the processor with a mechanism to properly inherit the context of the main thread so that execution may continue on the assist thread.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for reducing a penalty for executing a correct branch of a branch instruction, the method comprising:
executing, by a execution unit in a processor of the data processing system, a first branch of the branch instruction from a main thread of the processor;
executing, by the execution unit, a second branch of the branch instruction from an assist thread of the processor;
determining, by the execution unit, whether the main thread is the correct branch of the branch instruction or the assist thread is the correct branch of the branch instruction;
responsive to the assist thread being the correct branch of the branch instruction, pausing, by the execution unit, execution of the branch instruction on both the main thread and the assist thread; and
properly inheriting, by the execution unit, a context of the main thread in order that execution of the second branch may continue until the branch instruction completes.

2. The method of claim 1, wherein properly inheriting the context of the main thread in order that execution of the second branch may continue without penalty further comprises:
updating, by the execution unit, a thread virtualization table to discard a current assist thread identifier and change a virtual identifier of the assist thread to a main thread identifier;
squashing, by the execution unit, the main thread; and
continuing execution, by the execution unit, of the second branch of the branch instruction from the assist thread using the main thread identifier without penalty until the branch instruction completes.

3. The method of claim 2, wherein, by changing the virtual identifier of the assist thread to the main thread identifier, the assist thread properly inherits the context of the main thread so that execution may continue on the assist thread without penalty.

4. The method of claim 1, wherein the determination of whether the main thread is the correct branch of the branch instruction or the assist thread is the correct branch of the branch instruction is performed at a time during the execution of branches of the branch instruction when the execution unit resolves the branches.

5. The method of claim 1, wherein properly inheriting the context of the main thread in order that execution of the second branch may continue without penalty further comprises:
squashing, by the execution unit, all in-flight instructions to the main thread;
moving, by the execution unit, all in-flight instructions to the assist thread to the main thread;
setting, by the execution unit, a main threads program counter to a value of a program counter of the assist thread; and
continuing execution, by the execution unit, of the in-flight instructions that had been intended for the assist thread and are now coming from the main thread until the branch instruction completes.

6. The method of claim 5, wherein the in-flight instructions to the assist thread are moved to the main thread by modifying entries in at least one of a global completion table (GCT) or a load store queue (LSQ).

7. The method of claim 1, further comprising:
responsive to the main thread being the correct branch of the branch instruction, squashing, by the execution unit, the assist thread; and
continuing execution, by the execution unit, of the first branch of the branch instruction from the main thread until the branch instruction completes.

8. A computer program product comprising a computer readable storage medium having a computer readable program stored therein, wherein the computer readable program, when executed on a computing device, causes the computing device to:
execute a first branch of a branch instruction from a main thread of a processor;
execute a second branch of the branch instruction from an assist thread of the processor;
determine whether the main thread is a correct branch of the branch instruction or the assist thread is the correct branch of the branch instruction;
responsive to the assist thread being the correct branch of the branch instruction, pause execution of the branch instruction on both the main thread and the assist thread; and
properly inherit a context of the main thread in order that execution of the second branch may continue until the branch instruction completes.

9. The computer program product of claim 8, wherein the computer readable program to properly inherit the context of the main thread in order that execution of the second branch may continue without penalty further causes the computing device to:
update a thread virtualization table to discard a current assist thread identifier and change a virtual identifier of the assist thread to a main thread identifier;
squash the main thread; and
continue execution of the second branch of the branch instruction from the assist thread using the main thread identifier with no penalty until the branch instruction completes.

10. The computer program product of claim 9, wherein, by changing the virtual identifier of the assist thread to the main thread identifier, the assist thread properly inherits the context of the main thread so that execution may continue on the assist thread without penalty.

11. The computer program product of claim 8, wherein the determination of whether the main thread is the correct branch of the branch instruction or the assist thread is the correct branch of the branch instruction is performed at a time during the execution of branches of the branch instruction when an execution unit resolves the branches.

12. The computer program product of claim 8, wherein the computer readable program to properly inherit the context of the main thread in order that execution of the second branch may continue without penalty further causes the computing device to:
squash all in-flight instructions to the main thread;
move all in-flight instructions to the assist thread to the main thread;
set a main thread's program counter to a value of a program counter of the assist thread; and
continue execution of the in-flight instructions that had been intended for the assist thread and are now coming from the main thread until the branch instruction completes.

13. The computer program product of claim 12, wherein the in-flight instructions to the assist thread are moved to the main thread by modifying entries in at least one of a global completion table (GCT) or a load store queue (LSQ).

14. The computer program product of claim 8, wherein the computer readable program further causes the computing device to:
responsive to the main thread being the correct branch of the branch instruction, squash the assist thread; and
continue execution of the first branch of the branch instruction from the main thread until the branch instruction completes.

15. An apparatus, comprising:
a processor; and
a memory coupled to the processor, wherein the memory comprises instructions which, when executed by the processor, cause the processor to:
execute a first branch of a branch instruction from a main thread of the processor;
execute a second branch of the branch instruction from an assist thread of processor;
determine whether the main thread is a correct branch of the branch instruction or the assist thread is the correct branch of the branch instruction;
responsive to the assist thread being the correct branch of the branch instruction, pause execution of the branch instruction on both the main thread and the assist thread; and
properly inherit a context of the main thread in order that execution of the second branch may continue until the branch instruction completes.

16. The apparatus of claim 15, wherein the instructions to properly inherit the context of the main thread in order that execution of the second branch may continue without penalty further causes the processor to:
update a thread virtualization table to discard a current assist thread identifier and change a virtual identifier of the assist thread to a main thread identifier;
squash the main thread; and
continue execution of the second branch of the branch instruction from the assist thread using the main thread identifier with no penalty until the branch instruction completes.

17. The apparatus of claim 16, wherein, by changing the virtual identifier of the assist thread to the main thread identifier, the assist thread properly inherits the context of the main thread so that execution may continue on the assist thread without penalty.

18. The apparatus of claim 15, wherein the determination of whether the main thread is the correct branch of the branch instruction or the assist thread is the correct branch of the branch instruction is performed at a time during the execution of branches of the branch instruction when an execution unit resolves the branches.

19. The apparatus of claim 15, wherein the instructions to properly inherit the context of the main thread in order that execution of the second branch may continue without penalty further causes the processor to:
squash all in-flight instructions to the main thread;
move all in-flight instructions to the assist thread to the main thread;
set a main thread's program counter to a value of a program counter of the assist thread; and
continue execution of the in-flight instructions that had been intended for the assist thread and are now coming from the main thread until the branch instruction completes.

20. The apparatus of claim 19, wherein the in-flight instructions to the assist thread are moved to the main thread by modifying entries in at least one of a global completion table (GCT) or a load store queue (LSQ).

21. The apparatus of claim 15, wherein the instructions further cause the processor to:
responsive to the main thread being the correct branch of the branch instruction, squash the assist thread; and
continue execution of the first branch of the branch instruction from the main thread until the branch instruction completes.
